(19) United States
(12) Patent Application Publication
(10) Pub. No.: US 2012/0325887 A1
(43) Pub. Date: Dec. 27, 2012

(54) FASTENER DRIVING TOOL

(75) Inventor: Iwan WOLF, Untervaz (CH)

(73) Assignee: Hilti Aktiengesellschaft, Schaan (LI)

(21) Appl. No.: 13/450,733

(22) Filed: Apr. 19, 2012

(30) Foreign Application Priority Data
Apr. 19, 2011 (DE) 10 2011 007703.0

(51) Int. Cl. B25C 1/06

(52) U.S. Cl. 227/146

(57) ABSTRACT

The invention concerns a fastener driving tool comprising a drive motor, a gyrating mass, and a rammer head, wherein the gyrating mass above the drive motor can be made to rotate, wherein a spring mechanism can be tensioned by the gyrating mass via a detachable traction, in particular, a frictional locking, wherein the rammer head can be driven in a ramming direction via the tensioned spring mechanism.

### BACKGROUND OF THE INVENTION

The invention concerns a fastener driving tool, in particular, a hand-guided fastener driving tool according to the preamble of claim 1.

US 2009/0294505 A1 describes a fastener driving tool to drive a nail into a workpiece, in which an electric motor drives a rotating, gyrating mass, wherein by means of the gyrating mass and via a friction coupling, a rammer head to drive in the nail can be accelerated linearly.

### BRIEF SUMMARY OF THE INVENTION

It is the goal of the invention to indicate a fastener driving tool, which has a good driving-in energy.

This goal is attained with the characterizing features of claim 1 for a fastener driving tool mentioned in the beginning in accordance with the invention. By the combination of a gyrating mass with a spring mechanism, it is possible to remove energy taken from the gyrating mass over a longer period of time than, for example, in the direct driving of the rammer head. As a result, a high driving energy is made available in a simple manner. The gyrating mass is designed, in particular, as a flywheel. The detachable traction between the gyrating mass and the spring mechanism is understood to mean any known detachable coupling, for example, by means of friction, a form-locking coupling or a direct or indirect friction-locking coupling. The drive motor is preferably an electric motor but basically can also be another motor, such as a compressed air motor, or something similar.

In a preferred embodiment of the invention, provision is made so that the gyrating mass acts on the rammer head, wherein the rammer head pretensions the spring mechanism in a tensioning direction directed against the ramming direction. In this way, a particularly simple and low-cost mechanism is made available. The traction between the gyrating mass and the rammer head can be brought about, for example, by moving or pressing the flywheel or in some other known manner. In a simple implementation, therefore, the gyrating mass can be coupled with the rammer head directly, preferably, in a friction-locking manner. In an alternative development of the invention, the fastener driving tool comprises a clutch which is capable of selectively transferring energy from the gyrating mass to the rammer head. Preferaby, the clutch is a friction clutch. Such an arrangement can be particularly effective and/or offer advantages during the actuation process.

In another preferred embodiment, the fastener driving tool has a tensioning element for the tensioning of the spring mechanism. The gyrating mass thereby acts on the tensioning element, wherein the tensioning element pretensions the spring mechanism in a tensioning direction that is directed, in particular, against the ramming direction, whereas the rammer head is, with particular preference, at rest.

It is generally advantageous if the gyrating mass and its speed are designed in such a manner that in the rotating movement of the gyrating mass before the detachable traction, more than one ramming energy of the fastener driving tool is contained. In particular, at least twice the ramming energy can be contained, so as to guarantee the rapid and reliable tensioning of the spring element.

In the interest of an effective utilization of an electric motor and its drive energy, provision is made so that the electric motor passes through, in one regular operating mode, a multiple of successive driving processes without changing its rotating direction. This complies, in particular, with the characteristics of electric motors. In this way, for example, the advantage of a smaller design of the electric motor can be attained.

In a particularly simple and favorable model, provision is made so that the drive of the rammer head can be triggered in the tensioning direction by an operator using an actuation element. In a model alternative to this or supplementing it, however, a triggering of the previously tensioned spring mechanism can take place by means of the actuation element. The interaction between the actuation element and the drive mechanism can take place either in a purely mechanical manner or by means of control electronics.

It is generally advantageous if the spring element comprises a gas spring, preferably, a pretensioned gas spring. Depending on the requirements, however, a traditional spring, for example, a helical spring made of steel, titanium, rubber, or particularly, a fiber-reinforced plastic, can be used.

In a preferred embodiment, the spring mechanism comprises with particular preference individual springs arranged symmetrically to one another, and with particular preference moving simultaneously in opposite directions.

### BRIEF DESCRIPTION OF THE SEVERAL VIEWS OF THE DRAWING(S)

Other features and advantages of the invention can be deduced from the embodiment example and from the dependent claims. Below, preferred embodiments of the invention are described and explained in more detail with the aid of the appended drawings.

FIGS. 1 and 2 show schematic total views of illustrative embodiments of fastener driving tools in accordance with the invention.

### DETAILED DESCRIPTION OF THE INVENTION

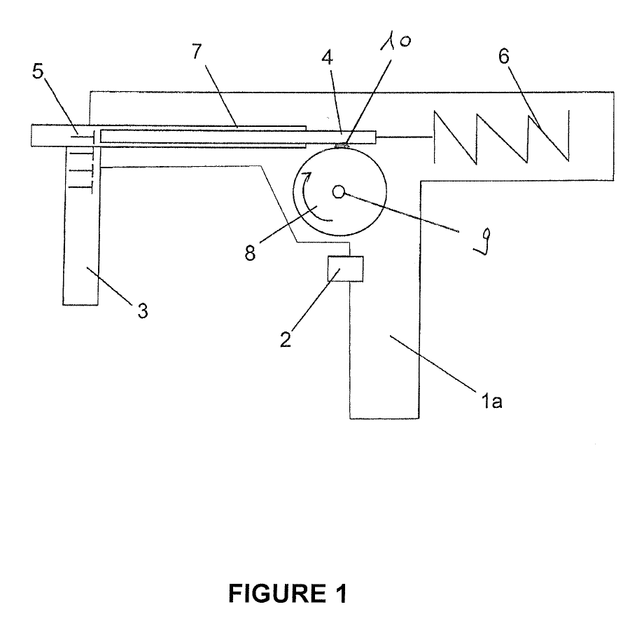

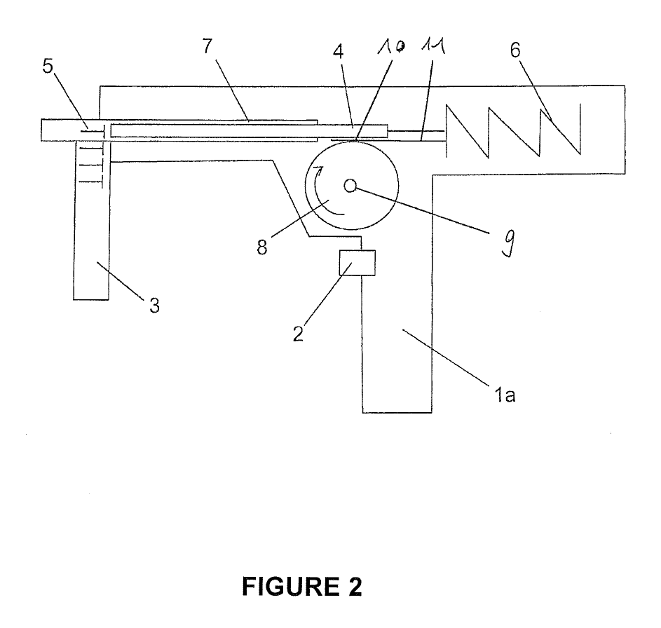

The fastener driving tools schematically shown in FIGS. 1 and 2 comprise a housing 1 with a handle la and an actuation element 2 located thereon for one operator. A nail magazine 3 is located on the end of the workpiece side, wherein nails can be driven by means of a rammer head 4 into a workpiece (not shown) from the nail magazine through an exit 5.

The rammer head 4 is driven by a spring mechanism 6 designed as a gas spring, which is schematically symbolized here as a helical spring. The rammer head 4 runs in sections in a head guide 7. Behind the head guide 7, a gyrating mass 8 designed as a flywheel is provided, which can be driven in a firm rotating direction via an electric motor 9. The detachable traction is symbolized as 10.

After actuation of the actuation element 2 by an operator, the flywheel 8 is pressed against the back end of the advanced rammer head 4 or the rammer head held by the pretensioned gas spring 6 in the triggered position, for example, by means of a simple mechanism between the actuation element 2 and the flywheel 8. By means of this detachable friction-locking coupling, the rammer head 4 is pretensioned against the pressure of the gas spring in the tensioning direction (in the drawing, from left to right) until it reaches a completely tensioned position (not shown). From this position, the flywheel 8 is decoupled, for example, by an automatic mechanism in moving over a cam through the rammer head, or something similar. Accordingly, the rammer head shoots forward from the gas spring 6 driven in the ramming direction (from right to left) and drives a nail already held in the magazine into the workpiece.

The embodiment of the fastener driving tool shown in FIG. 2 includes the elements described above, and also includes tensioning element 11, for providing tension on the spring mechanism 11. The tensioning element pretensions the spring mechanism in a tensioning direction that is directed, in particular, against the ramming direction, whereas the rammer head is, with particular preference, at rest. Subsequently, the flywheel can be decoupled, and the rammer head shoots forward in the ramming direction (from right to left), driving a nail into the workpiece.

Advantageously, the electric motor continues in the same rotating direction during the entire process and also the following repetitions, wherein the flywheel also advantageously never comes to a standstill. In this way, during a typical sequence of ramming processes, as a whole a particularly effective operation of the motor can be attained.

Of course, an appropriate provision can be made so that the motor becomes inactive during a sufficiently long pause, or the flywheel rolls out, so as to save energy. This can be attained by intelligent control electronics or also by actuation by the operator.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A fastener driving tool comprising a drive motor, a gyrating mass, a rammer head, and a spring mechanism; wherein the gyrating mass is rotatable by the drive motor, and the spring mechanism can be tensioned by the gyrating mass via a detachable traction, wherein the rammer head can be driven in a ramming direction via the tensioned spring mechanism.

2. The fastener driving tool according to claim 1, wherein the gyrating mass pretensions the spring mechanism in a tensioning direction that is directed against the ramming direction.

3. The fastener driving tool according to claim 1, comprising a tensioning element for the tensioning of the spring mechanism, and the gyrating mass acts on the tensioning element, wherein the tensioning element pretensions the spring mechanism in a tensioning direction that is directed against the ramming direction, wherein the rammer head is at rest.

4. The fastener driving tool according to claim 1, wherein the gyrating mass can be directly coupled with the rammer head via friction.

5. The fastener driving tool according to claim 1, wherein the traction comprises a clutch capable of selectively transferring energy from the gyrating mass to the rammer head.

6. The fastener driving tool according to claim 1, wherein in the rotating movement of the gyrating mass before the detachable traction, more than one ramming energy of the fastener driving tool is contained.

7. The fastener driving tool according to claim 1, wherein the driver motor is an electric motor, and the electric motor goes through, at least in a regular operating mode, a multiple of successive driving processes without changing its rotating direction.

8. The fastener driving tool according to claim 1, wherein the drive of the rammer head in the tensioning direction can be triggered by an operator by means of an actuation element.

9. The fastener driving tool according to claim 1, wherein the spring mechanism comprises a gas spring.

10. The fastener driving tool according to claim 1, wherein the spring mechanism comprises a helical spring.

11. The fastener driving tool according to claim 1, wherein the spring mechanism comprises two individual springs, which are arranged symmetrically with respect to one another and moving simultaneously in opposing directions.

12. The fastener driving tool according to claim 1, wherein the detachable traction comprises friction.

13. The fastener driving tool according to claim 2, wherein the gyrating mass can be directly coupled with the rammer head via friction.

14. The fastener driving tool according to claim 3, wherein the gyrating mass can be directly coupled with the rammer head via friction.

15. The fastener driving tool according to claim 9, wherein the gas spring comprises a pretensioned gas spring.

16. The fastener driving tool according to claim 10, wherein the helical spring comprises a steel spring or a carbon fiber spring.

17. The fastener driving tool according to claim 2, wherein the spring mechanism comprises a gas spring.

18. The fastener driving tool according to claim 2, wherein the spring mechanism comprises a helical spring.

19. The fastener driving tool according to claim 2, wherein the spring mechanism comprises two individual springs, which are arranged symmetrically with respect to one another and moving simultaneously in opposing directions.

20. The fastener driving tool according to claim 3, wherein the spring mechanism comprises a gas spring.
